(19) United States
(12) Patent Application Publication
(10) Pub. No.: US 2009/0139545 A1
(43) Pub. Date: Jun. 4, 2009

(54) CHEMICAL INJECTION FOR VEHICLE WASH SYSTEM AND METHOD

(76) Inventors: Chris Rowlands, London (CA); Colin Potts, London (CA)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 12/274,882

(22) Filed: Nov. 20, 2008

Related U.S. Application Data
(60) Provisional application No. 60/991,850, filed on Dec. 3, 2007.

(51) Int. Cl. B60S 3/04; B05B 7/32

(52) U.S. Cl. 134/18; 134/57 R; 134/36

(57) ABSTRACT

An apparatus includes an application pump that pumps water through a water application line. Fast-acting valves control a flow of different chemical concentrates into the water application line, and a controller is connected to each of the valves and programmed with a chemical injection pulse solenoid algorithm for optimal control of the chemical concentrate. The apparatus provides direct chemical injection into vehicle wash systems through the use of the fast-acting solenoid valves which rapidly turned on and off, creating an accurate and variable means of metering highly concentrated chemicals. Algorithms are used to control operation of the fast-acting solenoids, “pulsing” them in accordance to chemical type and application. The particular algorithm used preferably balances end performance and consistency with mechanical considerations such as actuation lag time, valve longevity, and wash equipment variables.

### CROSS-REFERENCE TO RELATED APPLICATION

This application claims benefit under 35 U.S.C. §119(e) of provisional application Ser. No. 60/991,850, filed Dec. 3, 2007, entitled CHEMICAL INJECTION FOR VEHICLE WASH SYSTEM AND METHOD, the entire contents of which are incorporated herein in their entirety.

### BACKGROUND

The present invention relates to vehicle wash systems and related methods, and more particularly relates to a chemical injection method and apparatus for handling and uniformly injecting highly concentrated chemicals in the water used in vehicle wash systems.

Current vehicle wash equipment systems rely on one or more dilution or mixing steps to dilute highly-concentrated solutions with water before the water-diluted solutions are suitable for end use or application to the vehicle in a washing process. The reason for the dilution/mixing steps is because current technology and application systems do not exist for injecting the highly-concentrated solutions directly into the application water of a vehicle wash system with sufficient uniformity. If the chemicals are not sufficiently uniformly mixed into the application water, a variety of quality problems result (depending on the chemical), such as poor or spotty cleaning, non-uniform application of protective coatings, or blotchy areas lacking adequate chemical treatment, and patches of water spots leaving droplet residue, to name a few.

This problem is aggravated by current trends in chemical production, which have produced continually more concentrated chemicals in order to reduce packaging and transportation costs as much as possible. This is usually accomplished by reducing the amount of carrier water in the highly concentrated chemicals as shipped. Typically, two situations arise in present vehicle wash applications. The first takes the chemical concentrate and dilutes it with water in an open tank at a fixed dilution rate. This diluted chemical is usually then pumped from the tank and directly applied through the vehicle wash equipment. The second situation also takes the chemical concentrate and dilutes it, but then further dilutes the chemical (such as up to 10:1 dilution) through the use of needle valves or inline injectors to be applied through the vehicle wash equipment. Regardless of application, an initial “manual” dilution is required involving manual mixing and/or storage of vehicle wash chemicals to create a less-concentrated solution of concentrate usable by current vehicle wash equipment standards.

As noted above, some existing vehicle wash systems include valves for injecting pre-diluted chemicals at a ratio of up to about 10:1. However, known systems are not able to handle injection of highly concentrated chemicals requiring dilutions of 20:1 to 50:1, and certainly are not able to inject super-concentrated chemicals requiring dilutions of 100:1 to 500:1 (or sometimes 1000:1 or more). Further, known systems are not flexible, and are unable to quickly, automatically, or accurately adjust to compensate for variation of the chemical concentrate and for variation in equipment operation and/or based on selection of washing options and/or for effective overall system performance. Notably, many vehicle wash systems are notoriously low tech and run by operators unable to perform significant plumbing repair.

### SUMMARY OF THE PRESENT INVENTION

In one aspect of the present invention, an apparatus for vehicle wash systems includes a diluted-chemical-and-water application line, an application pump for pumping water through the application line, and a plurality of sources of different chemical concentrates. Fast-acting valves are provided for controlling a flow of each different chemical concentrate into the application line, and a controller is connected to each of the valves and programmed with a chemical injection pulse algorithm for optimal control of the chemical concentrate to create a uniform flow of chemical concentrate into in the application line at a dilution rate of at least 50:1.

In another aspect of the present invention, an apparatus includes an application pump for pumping water through a water application line, at least one fast-acting solenoid valve for controlling flow of at least one highly concentrated chemical concentrate directly into the water application line, and a controller connected to the at least one fast-acting valve. The controller is programmed with a chemical injection pulse solenoid algorithm for controlling flow of the chemical concentrate, the algorithm rapidly turning on and off the fast-acting solenoid valve to create an accurate and variable means of metering the highly concentrated chemical.

In another aspect of the present invention, a method for controlling chemical concentrates in vehicle wash systems comprises steps of providing a diluted-chemical-and-water application line, providing an application pump for pumping water through the water application line, and connecting a water source to the application pump. The method further includes providing multiple sources of different chemical concentrates, providing a solenoid valve for controlling a flow of each different chemical concentrate into the water application line, and pumping each of the different chemical concentrates to the associated valve. The method still further includes providing a controller connected to each of the valves, programming the controller, and pulsing the valves to achieve optimal control of a uniform flow and mix of the chemical concentrates.

In another aspect of the present invention, a method includes directly injecting super-concentrated chemicals into a water application line of a vehicle wash system and pumping water through the water application line to wash a vehicle.

An object of the present invention is to eliminate dilution steps and mixing tanks prior to the point of use, and to use chemical products as provided by chemical manufacturers in their original highly-concentrated or super-concentrated state.

An object of the present invention is to use a direct injection system to apply highly-concentrated and super-concentrated chemicals into pressurized application lines in a vehicle wash system.

These and other aspects, objects, and features of the present invention will be understood and appreciated by those skilled in the art upon studying the following specification, claims, and appended drawings.

### BRIEF DESCRIPTION OF DRAWINGS

FIG. 1 is a flow/plumbing schematic showing a preferred apparatus and method of the present invention.

### DETAILED DESCRIPTION OF PREFERRED EMBODIMENTS

The present apparatus and method allow direct chemical injection of chemical concentrates into a stream of application water (i.e. the water flowing onto a vehicle in a vehicle wash system). This eliminates the need for additional manual dilution and/or mixing steps prior to injection of the chemical concentrate into the stream of application water, thus simplifying the process of using the chemical, reducing man-power, reducing capital investment in tanks and equipment related to the manual dilution and/or mixing process, providing increased flexibility and quick adjustability of dilution, and leading to a more efficient process. However, highly concentrated chemicals when in concentrations requiring dilution into water of more than 20:1 to 50:1 (or especially when requiring dilution of 100:1 or even 500:1 or even 1000:1) are difficult to add directly into a water application system, since even small quantities of the highly concentrated chemicals are “too much” for a given amount of water. Thus, the addition sequence may tend to lead to over-concentrations followed by under-concentrations in the diluted chemical-carrying water, unless the system is able to adequately control the flow of highly concentrated chemical into the pressurized application lines. The present system is well adapted for directly injecting highly concentrated chemicals into pressurized flowing application water. By highly concentrated chemicals, we mean a chemical concentrate requiring a dilution of at least about 20:1 to over 50:1 (water:chemical-concentrate). By super concentrated chemicals, the following concentration is meant: a dilution is required of at least about 100:1, or sometimes 500:1 to even 1000:1 (or more) is required. Notably, it is contemplated that in the future, chemicals will become even more concentrated, such that the present apparatus and method are even more applicable and important.

In the present system, direct chemical injection of highly concentrated chemicals is accomplished through the use of fast-acting solenoid valves which an algorithm rapidly turns on and off (such as 120 cycles/minute of the solenoid valves for pumping 250 ml/min of highly concentrated chemical to create a sufficiently uniform mix in the application water line). By adjusting the algorithm using a controller, the arrangement provides an accurate and variable means of metering the highly concentrated chemicals for use in vehicle wash systems while providing an acceptably constant concentration of the chemical in the application water. Algorithms are used to control operation of the fast-acting solenoids, “pulsing” them in accordance to chemical type and application. The particular algorithm used preferably balances end performance and consistency with mechanical considerations such as actuation lag time, valve longevity, and other wash equipment variables.

The preferred algorithm for each system varies, depending on its particular needs. An exemplary algorithm is given below. These algorithms allow for a dynamically variable chemical injection process unattainable through a fixed rate dilution system. The algorithms are executed by a programmable logic controller or “PLC.” Chemical concentrate is drawn (or pumped) and directly delivered to the solenoid at the injection point. The injection point is typically a low pressure water line providing the means to dilute the chemical concentrate to the desired concentration near the point of application. This final chemical mixture is typically fed to the application point through a second pump.

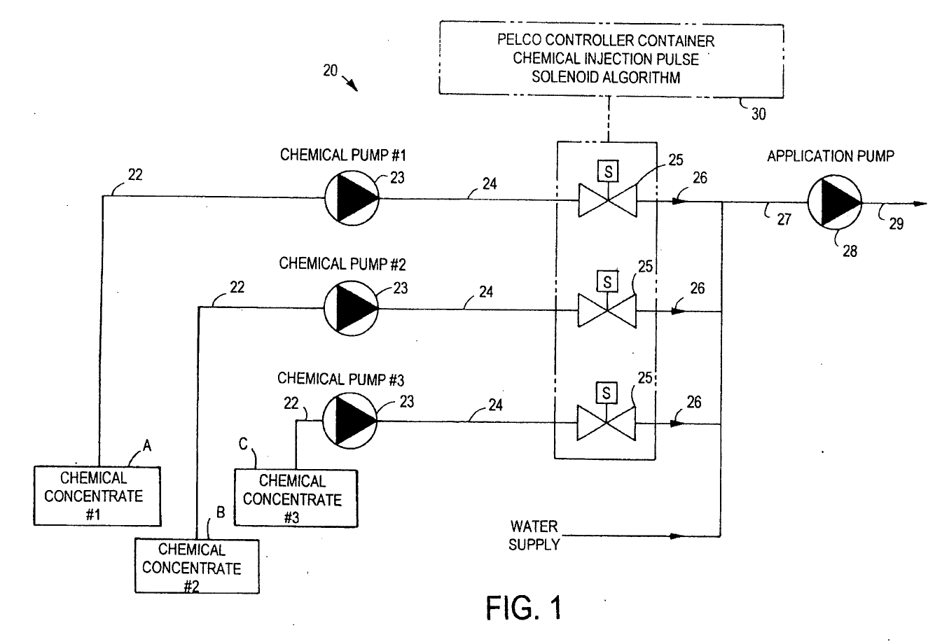

The illustrated chemical injection apparatus 20 (FIG. 1) for vehicle wash systems includes multiple sources of chemical concentrate, illustrated as concentrates A, B, and C. (A greater or lesser number of chemical concentrates can be used.) A concentrate supply line 22 leads from each concentrate to an associated pump 23. Fluid is pumped from pump 23 through an intermediate line 24 to a fast-acting pulse-type solenoid valve 25. An individual discharge line 26 communicates fluid from each valve 25 into a common water supplv line 27. The common water supply line 27 is connected to an application pump 28, such that water along with appropriate concentrations of diluted-and-mixed chemical product is dispensed out a single discharge line 29. The lines 27 and 28 are referred to herein as a “diluted-chemical-and-water application line.” The valve 25 for each chemical concentrate includes a solenoid “5” controlled by a controller 30 containing a chemical injection pulse solenoid algorithm for optimal control of the chemical concentrate, including diluting and/or mixing. The algorithm is preferably designed to provide an optimal balance of end performance and chemical consistency, given mechanical considerations of the wash equipment, such as actuation lag time, valve longevity, and similar wash equipment variables. The controller is preferably programmable and includes multiple algorithms that can be selected for particular needs . . . thus allowing the system to be adjusted automatically and quickly as needed and as different car wash options are selected by an operator.

The present direct injection system utilizes high speed pulsing solenoids and the associated algorithms represent a unique approach to chemical management and application in vehicle wash equipment, simplifying the process of using the chemical, reducing man-power, reducing capital investment in tanks and equipment related to the manual dilution and/or mixing process, and leading to a more efficient process.

### Example

By way of example, self-serve car washing services and features typically fall into three categories: high-pressure functions, low pressure functions, and applied functions. High pressure functions include rinse (hot, warm, cold), high pressure detergent (typically applied with hot water), and high pressure wax (typically applied with hot water). Low pressure functions include pre-soak (typically applied with the addition of compressed air for foaming action), tire cleaner (typically applied with the addition of compressed air for foaming action), spot free rinse (reverse osmosis water), and other features that operate in essentially the same way. Applied functions are the foaming brush and the foaming conditioner, both of which are often applied in three modulating colors.

### Direct Injection

Pelco's direct injection system eliminates the need for an initial dilution process and holding tank prior to further injection or application of car washing chemicals. The surfactant or wax products pass through dedicated modulating or pulsing solenoids that dilute the chemicals at the desired rate. The alkaline solution for high and low pressure functions pass through a single pulsing solenoid which changes the dilution rate depending on the function in use creating a stronger or weaker alkaline solution as needed.

The highly concentrated chemicals of two different suppliers were tested, and are referred to as: test #1 (using Supplier #1 chemical products) and test #2 (Supplier #2 chemical products). Fast acting solenoid valves were used mounted to a manifold, which provided system flexibility and expansion to both new equipment designs and upgrades to existing equipment in the field. Dilution rates of 30:1 up to over 1000:1 (application water volume:chemical volume) were achieved during the tests.

Common system attributes for both tests were:
Max Flow through Solenoid Valve Manifold: 4 GPM. Max flow per solenoid for the hot water solenoid was 4 GPM, 120 Degrees Fahrenheit, 60 PSI; and for the cold water solenoid was 4 GPM, Ambient, 60 PSI; for the spot free rinse solenoid was 2.8 GPM, 40-70 PSI.
Results of test #1 using Supplier #1 Highly Concentrated Products

Flow Rates per Solenoid: (Pressure Differential 15 PSI)

| | |
|---|---|
| High Pressure Soap Solenoid: | good control in desired range 8-15 ml/min. |
| High Pressure Wax Solenoid: | good control in desired range 8-15 ml/min. |
| Presoak Solenoid: | good control in desired range |
| | 15-50 ml/min. |
| Tire Cleaner Solenoid: | good control in desired range |
| | 50-75 ml/min. |

Total of 7 Solenoids required for Supplier #1 highly concentrated chemicals per self-serve carwash test #1.
Supplier #2 Highly Concentrated Chemical/Variability Achieved:

Flow Rates per Solenoid (Pressure Differential 15 PSI)

| | |
|---|---|
| High Pressure Soap Solenoid: | good control in desired range |
| | 1.2-2.8 ml/min. |
| High Pressure Wax Solenoid: | good control in desired range 8-10 ml/min. |
| Presoak Solenoid: | good control in desired range |
| | 5-7.5 ml/min. |
| Tire Cleaner Solenoid: | good control in desired range |
| | 10-12.5 ml/min. |
| Alkaline Solenoid: | good control in desired range |
| | 30-500 ml/min. |

Total of 8 solenoids required for Supplier #2 highly concentrated chemicals per self-serve car wash test #2. Notably an application water flow of 4 GPM (i.e., about 16 liters) and a concentrated chemical flow of 500 ml/min. is a dilution rate of about 32:1. For a concentrated flow of 5.0 ml, the dilution rate is about 3200:1.

### Valve Selection

Valve: Fast-acting solenoid valve on manifold
Orifice Size: 0.063″
Valves were noted for use with: Disinfectants and solvents, strong acids and bases, oxidizing solutions

### Flow Calculations (Theoretical)

Using: GPM=Cv\sqrt{ΔP}

ΔP=75 PSI (injection pressure)−60 PSI (line pressure)

Cv=0.071 (water) [gpm]

∴GPM=0.071\sqrt{15}

GPM=0.275

Maximum chemical flow rate=0.275 GPM=1041 ml/min=0.01735 ml/ms

### Flow Calculations (Practical)

| | | |
|---|---|---|
| Solenoid Actuation Time (Mechanical) = | 25 ms | (S_{AT}) |
| Solenoid De-actuation Time (Mechanical) = | 25 ms | (S_{DT}) |
| Relay Actuation Time (Mechanical) = | 7 ms | (R_{AT}) |
| Relay De-actuation Time (Mechanical) = | 11 ms | (R_{DT}) |
| Program Scan Time = | 0.1 ms | (internally |
| | | compensated) |

Consideration for mechanical actuation lag times assuming no flow until mechanical actuation times complete:

R_{AT}+S_{AT}+R_{DT}S_{DT}=minimum pluse time

Therefore, 7 ms+25 ms+11 ms+25 ms=68 ms for minimum pulse time

For practical purposes considering potential lag in actuation, a maximum pulse division of 500 ms or 120 cycles per minute was tested. This provided adequate injection adjustment while minimizing extraneous valve wear. The valves used were rated for up to 300 c.p.m. Test data was taken to confirm whether the injection appeared uniform at point of use.

Initial Test Data

| | | Reading A | Reading B | | |
|---|---|---|---|---|---|
| Parameter A | Parameter B | (Graduated Cylinder) | | Result | |
| 10 | 0 | 500 | 500 | 0 | ml/min |
| 25 | 0 | 498 | 498 | 2 | ml/min |
| 50 | 0 | 500 | 490 | 10 | ml/min |
| 100 | 0 | 490 | 461 | 29 | ml/min |
| 150 | 0 | 500 | 462 | 38 | ml/min |
| 50 | 1 | 500 | 493 | 7 | ml/min |
| 50 | 1 | 500 | 489 | 11 | ml/min |
| 50 | 1 | 500 | 490 | 10 | ml/min |
| 50 | 10 | 500 | 485 | 15 | ml/min |
| 50 | 20 | 485 | 463 | 22 | ml/min |
| 50 | 20 | 463 | 443 | 20 | ml/min |
| 50 | 40 | 443 | 410 | 33 | ml/min |
| 50 | 50 | 410 | 372 | 38 | ml/min |
| 50 | 70 | 372 | 327 | 45 | ml/min |
| 100 | 70 | 327 | 267 | 60 | ml/min |
| 1000 | 0 | 500 | 250 | 250 | ml/min |

Parameter A - Injected concentrate (ml), variable
Parameter B - Timing adjustment (ms), variable
Reading A - Collected application water #1 (ml)
Reading B - Collected application water #2 (ml)
Result - Concentrate in collected application water

It is to be understood that variations and modifications can be made on the aforementioned structure without departing from the concepts of the present invention, and further it is to be understood that such concepts are intended to be covered by the following claims unless these claims by their language expressly state otherwise.

1. An apparatus for vehicle wash systems comprising:
a diluted-chemical-and-water application line;
an application pump for pumping water through the application line;
a plurality of sources of different chemical concentrates;
fast-acting valves for controlling a flow of each different chemical concentrate into the application line; and
a controller connected to each of the valves and programmed with a chemical injection pulse algorithm for optimal control of the chemical concentrate to create a uniform flow of chemical concentrate into the application line at a dilution rate of at least 50:1.

2. The apparatus defined in claim 1, wherein the multiple sources include at least three different chemical concentrates, and wherein the chemical concentrates include at least three different chemical concentrates, and wherein the controller is programmed to provide a predetermined ratio of the at least three different chemical concentrates.

3. The apparatus defined in claim 1, wherein the algorithm is designed to provide a mix of the chemicals designed for a desired balance of end performance and chemical consistency based on mechanical considerations of the vehicle wash equipment.

4. The apparatus defined in claim 1, wherein the controller is adapted to vary amounts of each concentrate for optimal control.

5. The apparatus defined in claim 1, wherein the valves are fast-acting solenoid valves

6. The apparatus defined in claim 1, wherein the controller is programmed to provide a series of pulses to control on-off movement of the valves.

7. The apparatus defined in claim 1, wherein the controller is adapted to vary amounts of each concentrate for optimal control, wherein the valves are fast-acting solenoid valves, and wherein the controller is programmed to provide a series of pulses to control on-off movement of the valves.

8. An apparatus comprising:
an application pump for pumping water through a water application line;
at least one fast-acting solenoid valve for controlling flow of at least one highly concentrated chemical concentrate directly into the water application line; and
a controller connected to the at least one fast-acting valve and programmed with a chemical injection pulse solenoid algorithm for controlling flow of the chemical concentrate, the algorithm rapidly turning on and off the fast-acting solenoid valve to create an accurate and variable means of metering the highly concentrated chemical.

9. A method for controlling chemical concentrates in vehicle wash systems comprising steps of:
providing a diluted-chemical-and-water application line;
providing an application pump for pumping water through the water application line;
connecting a water source to the application pump;
providing multiple sources of different chemical concentrates;
providing a solenoid valve for controlling a flow of each different chemical concentrate into the water application line;
pumping each of the different chemical concentrates to the associated valve;
providing a controller connected to each of the valves;
programming the controller; and
pulsing the valves to achieve optimal control of a uniform flow and mix of the chemical concentrates in the water application line.

10. A method for washing vehicles comprising:
directly injecting super-concentrated chemicals into a water application line of a vehicle wash system; and
pumping water through the water application line to wash a vehicle.
